(19) United States
(12) Patent Application Publication
(10) Pub. No.: US 2007/0238464 A1
(43) Pub. Date: Oct. 11, 2007

(54) Apparatus and method for performing handover in a communication system

(75) Inventors: Ae-Ri Lim, Suwon-si (KR); Kang-Gyu Lee, Yongin-si (KR); In-Hyoung Kim, Suwon-si (KR); Yun-Sang Park, Suwon-si (KR); Bong-Gee Song, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/731,009

(22) Filed: Mar. 29, 2007

(30) Foreign Application Priority Data
Mar. 29, 2006 (KR) 28416/2006
Apr. 10, 2006 (KR) 32531/2006

(51) Int. Cl. H04Q 7/20

(52) U.S. Cl. 455/436

(57) ABSTRACT

An apparatus and method for performing a handover in a communication system are provided. For the handover, an MS determines whether a handover process with a serving BS runs normally. If the handover process is abnormal, the MS notifies a target BS of the abnormal handover process and the target BS performs the handover with the MS using handover information corresponding to handover information lost due to the abnormal handover process.

### PRIORITY

This application claims priority under 35 U.S.C. § 119(a) to a Korean Patent Application filed in the Korean Intellectual Property Office on Mar. 29, 2006 and assigned Serial No. 2006-28416 and a Korean Patent Application filed in the Korean Intellectual Property Office on Apr. 10, 2006 and assigned Serial No. 2006-32531, the entire disclosure of which is hereby incorporated by reference.

### BACKGROUND OF THE INVENTION

1. Field of the Invention

The present invention generally relates to a handover in a communication system. More particularly, the present invention relates to an apparatus and method for performing a handover, which minimizes service delay during message transmission/reception, in a wireless communication system.

2. Description of the Related Art

Provisioning to users of services with different Quality of Service (QoS) requirements at high rates is experiencing extensive research as a future-generation communication system called a 4^{th} Generation (4G) communications systems. In particular, extensive research is being conducted in providing support of high-speed services by ensuring mobility and QoS to a Broadband Wireless Access (BWA) communication system such as Wireless Local Area Network (WLAN) or Wireless Metropolitan Area Network (WMAN) in the present 4G communication system. The communication system applies Orthogonal Frequency Division Multiplexing (OFDM)/Orthogonal Frequency Division Multiple Access (OFDMA) to WMAN physical channels in order to support a broadband transmission network.

A Base Station (BS) covers a service area, referred to as a cell, and provides services to Mobile Stations (MSs) within the cell in a typical cellular wireless communication system. An MS can move from a serving cell to a neighbor cell. In this situation the MS performs a handover from the serving BS to the target BS.

FIG. 1 is a diagram illustrating a signal flow for a handover process in a typical communication system. With reference to FIG. 1, a handover operation among an MS 100, a serving BS 130, and a target BS 160 will be described below.

Referring to FIG. 1, the MS 100 performs a communication service with the serving BS 130 by setting up a call. The MS 100 receives reference signals, for example, pilot signals from neighbor BSs, measures the Carrier-to-Interference and Noise Ratios (CINRs) of the pilot signals, and determines whether or not to change the serving BS 130, that is, whether to perform a handover.

If the MS 100 determines to change the serving BS from the current serving BS 130 to another BS, the MS 100 transmits a Mobile Station HandOver Request (MOB_MSHO-REQ) message to the serving BS 130 in step 111. The MOB_MSHO-REQ message is a Medium Access Control (MAC) layer message carrying neighbor BS information that the MS 100 has measured in order to perform a handover to another BS.

The serving BS 130 replies to the MS 100 with a Base Station HandOver Response (MOB_BSHO-RSP) message in step 113. The MOB_BSHO-RSP message is a MAC layer message including recommended BS information.

The MS 100 acquires handover information regarding the neighbor BSs from the MOB_BSHO-RSP message. While the MS 100 initiates the handover in the illustrated case of FIG. 1, the serving BS 130 may also initiate the handover without the MS's request, for load sharing or other reasons. Hence, while not shown, the serving BS 130 may transmit a Base Station HandOver Request (MOB_BSHO-REQ) message to the MS 100. The MOB_BSHO-REQ message is a MAC layer message by which the serving BS 130 requests a handover to the MS 100.

Handover information transmitted between the MS 100 and the serving BS 130 by the MOB_MSHO-REQ message, the MOB_BSHO-RSP message, and the MOB_BSHO-REQ message contains service level prediction information, handover process optimization information, HandOver IDentification (HO-ID) information, HO_authorization_policy_support information, and the like.

Upon receipt of the MOB_BSHO-RSP message, the MS 100 transmits in step 115 a HandOver Indication (MOB_HO-IND) message to the serving BS, notifying that the MS 100 will perform a handover to the target BS 160. Then, the MS 100 releases the call from the serving BS 130.

The MS 100 performs network re-entry to the target BS 160 as a new serving BS. The network re-entry covers ranging, re-negotiation, re-authentication, and re-registration between the MS 100 and the target BS 160.

The MS 100 transmits in step 117 a Handover Ranging Code (HO_Ranging-Code) to the target BS 160, for the handover.

The target BS 160 replies in step 119 to the MS 100 with a Ranging Response (RNG-RSP) message notifying that a successful ranging is possible for the HO_Ranging-Code. Then, the target BS 160 transmits in step 121 a Code Division Multiple Access_Allocation_Information Element (CDMA_Alloc_IE) to the MS 100.

Instead of steps 117, 119 and 121, the target BS 160 may transmit in step 123 a ranging information element, for example, a Fast Ranging Information Element (Fast_Ranging_IE) to the MS 100, for fast handover. As the Fast_Ranging_IE is delivered in an UpLink (UL) MAP, a CDMA code ranging procedure may not be performed.

As the target BS 160 transmits the CDMA_Alloc_IE or the Fast_Ranging_IE to the MS 100, the target BS 160 allocates an UpLink BandWidth (UL BW) in which the MS 100 will transmit a Raging-Request (RNG-REQ) message.

After acquiring downlink synchronization with the target BS 160, the MS 100 performs an uplink operation by the ranging to the target BS 160, thus acquiring uplink synchronization and being capable of controlling transmit power. In step 125, the MS 100 transmits basic information needed for a call connection to the target BS 160 by the RNG-REQ message. The target BS 160 replies with an RNG-RSP message in step 127.

After the ranging, the MS 100 transmits in step 129 a Subscriber Station Basic Capability Negotiation Request (SBC-REQ) message to the target BS 160 in order to negotiate the basic capabilities of the MS 100. The SBC-REQ message is a MAC layer message containing a modulation and coding scheme supportable by the MS 100. The target BS 160, which checks the MS-supported modulation and coding scheme from the SBC-REQ message, replies to the MS 100 with a Subscriber Station's Basic Capability Negotiation Response (SBC-RSP) message in step 131.

Upon receipt of the SBC-RSP message, the MS 100 transmits in step 133 a Privacy Key Management Request (PKM-REQ) message to the target BS 160, for MS authentication and key exchange. The PKM-REQ message is a MAC layer message for authentication of the MS 100, containing certificate information regarding the MS 100. The target BS 160 performs authentication with an Authentication Server (AS, not shown) using the certificate information. If the MS 100 is authenticated, the target BS 160 transmits in step 135 a Privacy Key Management Response (PKM-RSP) message to the MS 100. The PKM-RSP message includes an Authentication Key (AK) and a Traffic Encryption Key (TEK), both allocated to the MS 100.

The MS 100 transmits a Registration Request (REG-REQ) message to the target BS 160 in step 137. The REG-REQ message includes MS registration information regarding the MS 100. The target BS 160 detects the MS registration information in the REG-REQ message, registers the MS 100 to the target BS 160, and then transmits a Registration Response (REG-RSP) message to the MS 100 in step 139. The REG-RSP message includes MS registration information about the registered MS 200.

When the registration to the target BS 160 is completed, the MS 100 sets up an Internet Protocol (IP) connection to the target BS 160 or transmits operation parameters to the target BS 160 depending on the type of the MS 100 or whether information about the MS 100 is shared and transferred between the BSs 130 and 160. The IP connection setup or the transmission of operation parameters is optional. Then, the MS 100 reconfigures a flow serviced by the serving BS 130, thus reconfiguring a connection. With the connection reconfiguration, the MS 100 is now able to normally carry out a communication service with the target BS 160.

Part of the afore-mentioned re-negotiation, re-authentication, and re-registration with the target BS 160 may not be performed if agreed to between the serving BS 130 and the target BS 160 during the handover. The target BS 160 may notify whether a subsequent handover procedure is provided or not by an HO_process_optimization field of the RNG-RSP message for the RNG-REQ message transmitted from the MS 100. The MS 100 skips part of the re-negotiation, re-authentication, and re-registration according to the HO_process_optimization value.

FIG. 2 is a diagram illustrating a signal flow for a handover process when reception of a handover message fails.

Referring to FIG. 2, in a handover process among an MS 200, a serving BS 230, and a target BS 260, the MS 200 first performs a service with the serving BS 230 by setting up a call. The MS 200 receives reference signals, for example, pilot signals from neighbor BSs, measures the CINRs of the pilot signals, and determines whether or not to change the serving BS 230, that is, whether to perform a handover.

If the MS 200 determines to change the serving BS from the current serving BS 230 to another BS, the MS 200 transmits a MOB_MSHO-REQ message to the serving BS 230 in step 211. The MOB_MSHO-REQ message is a MAC layer message carrying neighbor BS information that the MS 100 has measured to perform a handover to another BS.

The serving BS 230 replies to the MS 200 with a MOB_BSHO-RSP message in step 213. The MOB_BSHO-RSP message is a MAC layer message including recommended BS information.

However, since messages are exchanged between the MS 200 and the BSs 230 and 260 at a cell boundary where the strengths of signals are weakened or in a handover region, the messages have a high transmission/reception failure probability. Hence, the case where the MS 200 fails to receive the MOB_BSHO-RSP message will be described herein.

Due to the failure of receiving the MOB_BSHO-RSP message, the MS 200 does not acquire handover information about neighbor BSs needed for a normal handover.

Also in the case where the serving BS 230 transmits a MOB_BSHO-REQ message to the MS 200, requesting a handover, errors may occur in transmission and reception of a handover message.

If the MS 200 does not receive the MOB_BSHO-RSP message for a predetermined time period, the MS 200 retransmits the MOB_MSHO-REQ message. Even if the MS 200 fails to receive the MOB_BSHO-RSP message after all despite a predetermined number of retransmissions of the MOB_MSHO-REQ message, or without any retransmission of the MOB_MSHO-REQ message, the MS 200 can perform the handover. Then the MS 200 transmits in step 215 a HandOver Indication (MOB_HO-IND) message to the serving BS 230, notifying that the MS 200 will perform a handover to the target BS 260. Then, the MS 200 releases the call from the serving BS 230. When the MS 200 is not allocated a UL BW and thus does not transmit the MOB_MSHO-REQ message, the MS 200 can also transmit the MOB_HO-IND message, thereby attempting cell switching. As described above, the MS 200 may decide on a handover and attempt cell switching by transmitting the MOB_HO-IND message, without transmitting the MOB_MSHO-REQ message or receiving the MOB_BSHO-RSP message.

Then, the MS 200 performs network re-entry to the target BS 260 as a new serving BS. The network re-entry covers ranging, re-negotiation, re-authentication, and re-registration between the MS 200 and the target BS 260. During the ranging, the target BS 260 may transmit in step 217 a Fast_Ranging_IE to the MS 230, for a fast handover. As the Fast_Ranging_IE is delivered in an UL MAP, the handover can be performed fast, skipping a CDMA code ranging procedure. As the target BS 260 transmits the Fast_Ranging_IE, the target BS 260 should allocate a UL BW in which the MS 200 can transmit an RNG-REQ message, and the MS 200 should transmit the RNG-REQ message in the allocated UL BW, for the ranging.

However, the serving BS 230 and the MS 200 do not transmit and receive the MOB_BSHO-RSP message or the MOB_BSHO-REQ message. Therefore, the MS 200, the serving BS 230, and the target BS 260 each have different handover information. When transmitting the Fast_Ranging_IE to the MS 200, the target BS 260 identifies the MS 200 by the MAC address of the MS 200 or an HO-ID allocated to the MS 200 by the MOB-BSHO-RSP message or the MOB-BSHO-REQ message during the handover process. The HO-ID is a 1-byte identifier, more efficient than the MAC address that is relatively long. The MS 200 uses the HO-ID in transmitting the RNG-REQ message or receiving the Fast_Ranging_IE or an RNG-RSP message.

Yet, when the handover process does not run normally due to a failure to receive the MOB_BSHO-RSP message or the MOB_BSHO-REQ message, the MS 200 fails to receive the HO-ID. As a consequence, the MS 200 does not receive the Fast_Ranging_IE successfully. In other words, the MS 200 does not know an uplink period in which it can transmit the RNG-REQ message.

In step 219, the MS 200 transmits a HO_Ranging-Code to the target BS 260, for network reentry. The target BS 260 replies to the MS 200 with an RNG-RSP message for the HO_Ranging-Code in step 221. Then, the target BS 260 transmits in step 223 a CDMA_Alloc_IE to the MS 200 to thereby allocate an uplink period for transmission of an RNG-REQ message from the MS 200 which has performed the ranging using a CDMA code.

It has been described above that due to the transmission/reception failure of the MOB_BSHO-REQ message or the MOB_BSHO-RSP message, different handover information exists in the MS 200 and the BSs 230 and 260, such as an HO-ID mismatch in relation to the Fast_Ranging_E. Because the MS 200 does not detect the uplink period that the target BS 260 has allocated to the MS 200 by the Fast_Ranging_IE, the uplink period is not accessible to the MS 200. Moreover, since the CDMA code ranging procedure is to be performed, the handover delay is lengthened.

After acquiring downlink synchronization with the target BS 260, the MS 200 should perform an uplink operation by ranging to the target BS 260 to acquire uplink synchronization and be capable of controlling transmit power. Thus, the MS 200 transmits an RNG-REQ message to the target BS 260 in step 225. The target BS 260 replies with an RNG-RSP message in step 227.

After the ranging, the MS 200 transmits an SBC-REQ message to the target BS 260 in order to negotiate the basic capabilities of the MS 200 in step 229. The SBC-REQ message is a MAC layer message containing a modulation and coding scheme supportable by the MS 200. The target BS 260, which checks the MS-supported modulation and coding scheme from the SBC-REQ message, replies to the MS 200 with an SBC-RSP message in step 231.

Upon receipt of the SBC-RSP message, the MS 200 transmits in step 233 a PKM-REQ message to the target BS 260, for MS authentication and key exchange. The PKM-REQ message is a MAC layer message for authentication of the MS 200, containing certificate information regarding the MS 200. The target BS 260 performs authentication with an AS (not shown) using the certificate information. If the MS 200 is authenticated, the target BS 260 transmits a PKM-RSP message to the MS 200 in step 235. The PKM-RSP message includes an AK and a TEK, both allocated to the MS 200.

The MS 200 transmits an REG-REQ message to the target BS 260 in step 237. The REG-REQ message includes MS registration information regarding the MS 200. The target BS 260 detects the MS registration information in the REG-REQ message, registers the MS 200 to the target BS 260, and then transmits an REG-RSP message to the MS 200 in step 239. The REG-RSP message includes MS registration information about the registered MS 200.

When the registration to the target BS 260 is completed, the MS 200 sets up an IP connection to the target BS 260 or transmits operation parameters to the target BS 260 depending on the type of the MS 200 or whether information about the MS 200 is shared and transferred between the BSs 230 and 260. The IP connection setup or the transmission of operation parameters is optional. Then, the MS 200 reconfigures a flow serviced by the serving BS 230, thus reconfiguring a connection. With the connection reconfiguration, the MS 200 is now able to normally carry out a communication service with the target BS 260.

HO-authorization_policy_support information included in the MOB_BSHO-REQ message and the MOB_BSHO-RSP message specifies an authentication policy for the handover process. However, when the MS 200 fails to receive these messages, the MS 200 and the target BS 260 have different handover authorization policy support information.

Part of the PKM process of steps 233 and 235 for the network entry can be skipped. Yet, with the different handover authorization policy support information between the MS 200 and the target BS 260, the skipping of the authentication, aiming at handover optimization, leads to an authentication failure for the MS 200 or an unnecessary operation between the MS 200 and the target BS 260.

Consequently, the failed transmission/reception of the MOB_BSHO-REQ message or the MOB_BSHO-RSP message results in an abnormal handover process among the MS, the serving BS, and the target BS. Because either of the serving BS or the target BS can determine if a handover signal has been received successfully at the MS, loss of the handover signal results in a mismatch of handover information among the MS and the BSs. Therefore, the handover fails or a service is delayed due to an increased handover time.

### SUMMARY OF THE INVENTION

An aspect of the present invention is to address at least the problems and/or disadvantages and to provide at least the advantages described below. Accordingly, an aspect of the present invention is to provide a handover apparatus and method for minimizing a service delay in a communication system.

Another aspect of the present invention provides a handover apparatus and method for minimizing a service delay against an abnormal handover process in a communication system.

A further aspect of the present invention provides a handover apparatus and method for minimizing a service delay in case of different HO-IDs among an MS and BSs in a communication system.

Still another aspect of the present invention provides a handover apparatus and method for minimizing a service delay in case of loss of a handover message in a communication system.

In accordance with an aspect of an exemplary embodiment of the present invention, there is provided a handover method of an MS in a communication system, in which handover is determined, when the MS that a handover is required; and a serving Base Station (BS) of the failed reception of handover information if the MS does not receive a BS handover message transmitted MS from the serving BS and tries cell switching to a target BS.

In accordance with another aspect of an exemplary embodiment of the present invention, there is provided a handover method of a serving BS in a communication system, in which received a notification indicating failed reception of the BS handover response message is received from the MS, and a target BS is notified of the failed reception of the handover information at the MS, the target BS being a BS to which the MS is to handover.

In accordance with a further aspect of an exemplary embodiment of the present invention, there is provided a handover method of a target BS in a communication system, in which a notification of a failed reception at an MS of handover information transmitted by a serving BS is received, and a bandwidth for ranging is allocated to the MS using a unique handover ID of the MS.

In accordance with still another aspect of an exemplary embodiment of the present invention, there is provided a handover method of an MS in a communication system, in which handover is determined, when the MS determines that a handover is required, a handover indication message is transmitted to a target BS to which the handover is to be performed, the handover is implemented with the target BS, and the target BS is notified of the failed reception of handover information.

In accordance with still further aspect of an exemplary embodiment of the present invention, there is provided a handover method of a target BS in a communication system, in which a handover is implemented with an MS, a notification of a failed reception at the MS of handover information transmitted by a serving BS is received from the MS, and it is determined that handover information about the MS is not valid.

In accordance with yet another aspect of an exemplary embodiment of the present invention, there is provided a handover apparatus in a communication system, in which handover is determined, when the MS determines that a handover is required, and a serving Base Station (BS) is notified of the failed reception of a handover information if the MS does not receive a BS handover message transmitted MS from the serving BS, and tries cell switching to a target BS.

In accordance with yet still another aspect of an exemplary embodiment of the present invention, there is provided a handover apparatus in a communication system, in which a serving BS receives form s Mobile Station (MS) a notification indicating a failed reception of handover information, and notifies a target BS of the failed reception at the MS of the handover information, the target BS being a BS to which the MS is to handover.

In accordance with a further aspect of an exemplary embodiment of the present invention, there is provided a handover apparatus in a communication system, in which a target BS receives a notification of failed reception at an MS of handover information transmitted by a serving BS, and allocates a bandwidth for ranging to the MS using a unique handover ID of the MS.

In accordance with yet a further aspect of an exemplary embodiment of the present invention, there is provided a handover apparatus in a communication system, in which Mobile Station (MS) determines handover, when the MS determines that a handover is required, transmits a handover indication message to a target BS to which the handover is to be performed, implements the handover with the target BS, and notifies the target BS of the failed reception of BS handover information.

In accordance with yet still another further aspect of an exemplary embodiment of the present invention, there is provided a handover apparatus in a communication system, in which a target BS implements a handover with an MS, receives from the MS a notification of failed reception at the MS of handover information transmitted by a serving BS, and determines that handover information about the MS is not valid.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a diagram illustrating a signal flow for a handover process in a typical communication system;

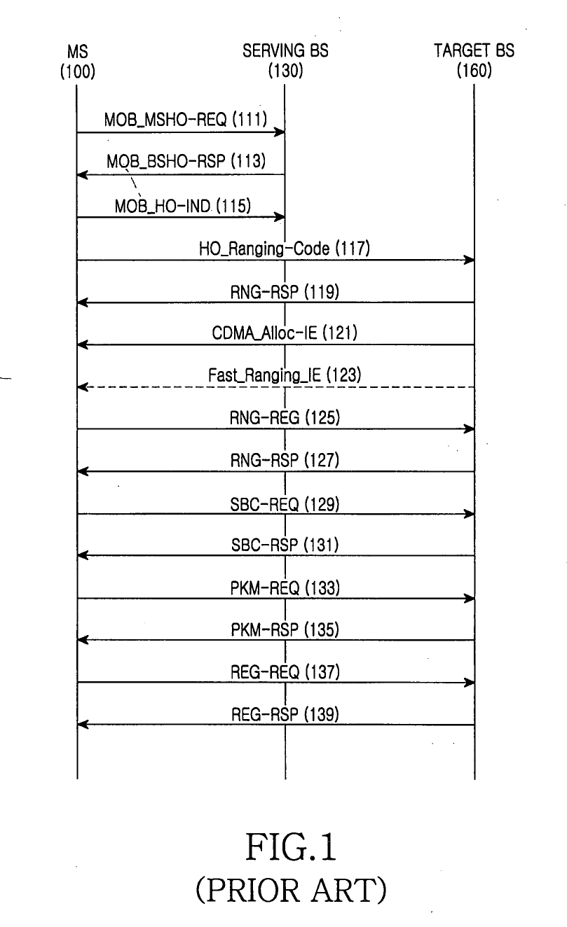

FIG. 2 is a diagram illustrating a signal flow for a handover process in case of failed transmission/reception of a handover message in the typical communication system;

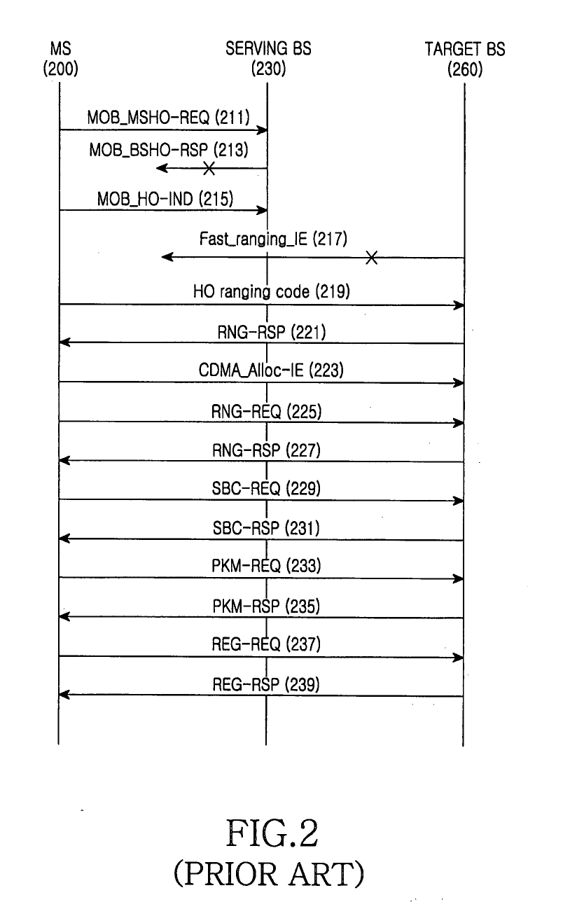

FIG. 3 is a diagram illustrating a signal flow for a handover process in a communication system according to an exemplary embodiment of the present invention;

FIG. 4 is a diagram illustrating a signal flow for a handover process in case of loss of a MOB_HO-IND message in the communication system according to an exemplary embodiment of the present invention;

FIG. 5 is a flowchart illustrating a handover operation of an MS according to an exemplary embodiment of the present invention;

FIG. 6 is a flowchart illustrating a handover operation of a serving BS according to an exemplary embodiment of the present invention;

FIG. 7 is a flowchart illustrating a handover operation of a target BS according to an exemplary embodiment of the present invention;

FIG. 8 is a diagram illustrating a signal flow for a handover process in the communication system according to another exemplary embodiment of the present invention;

FIG. 9 is a flowchart illustrating a handover operation of the MS according to another exemplary embodiment of the present invention; and

FIG. 10 is a flowchart illustrating a handover operation of the target BS according to another exemplary embodiment of the present invention.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In accordance with an exemplary embodiment of the present invention, upon detection of an abnormal handover process between an MS and BSs, the MS notifies a serving BS or a target BS that the handover process is abnormal and thus handover information about the MS is not valid, and the target BS performs the handover process, taking into account of loss information about the MS. To indicate to the BSs whether the handover process is normal or abnormal, an imminent HO try indication (Imminent_HO_try_indication) is used. Thus, the target BS supports the handover using a MAC address of the MS, instead of an HO-ID of the MS. The Imminent_HO_try_indication may be transmitted in the form of a message or inserted in the form of a Type, Length, Value (TLV) in a handover message. Also, the target BS transmits to the MS handover process optimization information based on the target BS information so that some steps of the handover process can be skipped.

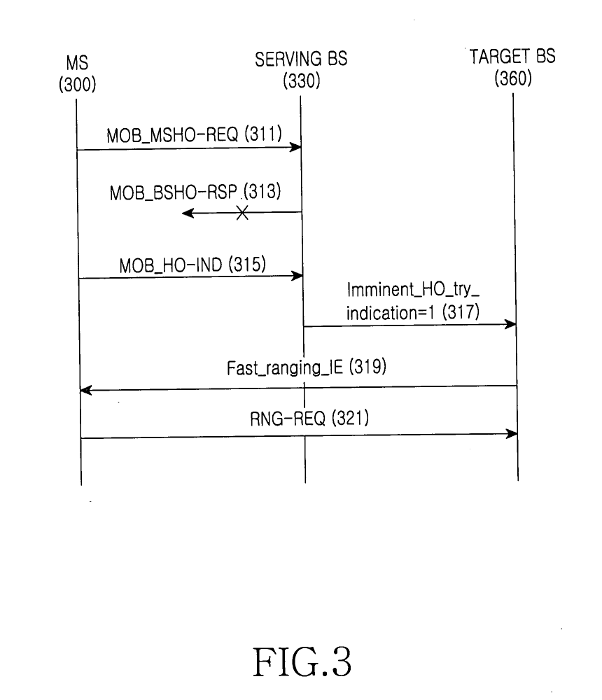

FIG. 3 is a diagram illustrating a signal flow for a handover process in a communication system according to an exemplary embodiment of the present invention.

Referring to FIG. 3, during a handover process among an MS 300, a serving BS 330, and a target BS 360, the MS 300 performs a service with the serving BS 330 by setting up a call. The MS 300 receives reference signals, for example, pilot signals, from neighbor BSs, measures the CINRs of the pilot signals, and determines whether or not to change the serving BS 330, that is, whether to perform a handover.

If the MS 300 determines to change the serving BS from the current serving BS 330 to another BS, the MS 300 transmits a MOB_MSHO-REQ message to the serving BS 330 in step 311. The MOB_MSHO-REQ message is a MAC layer message carrying neighbor BS information that the MS 300 has measured to perform a handover to another BS.

The serving BS 330 replies to the MS 300 with a MOB_BSHO-RSP message in step 313. The MOB_BSHO-RSP message is a MAC layer message including recommended BS information.

However, since messages are exchanged between the MS 300 and the BSs 330 and 360 at a cell boundary where the strengths of signals are weakened or in a handover region, the messages have a high transmission/reception failure probability. Hence, the MS 300 may fail to receive the MOB_BSHO-RSP message successfully in step 313 in the illustrated case of FIG. 3.

Due to the failure of receiving the MOB_BSHO-RSP message, the MS 300 does not acquire handover information about neighbor BSs needed for a normal handover. The handover information contains service level prediction information, handover process optimization information, HO-ID information, HO_authorization_policy_support information, and the like.

While not shown in FIG. 3 describing an MS-initiated handover, transmission/reception errors may occur in a MOB_BSHO-REQ message that the serving BS 330 transmits in the case of a BS-initiated handover. That is, reception of the MOB_BSHO-RSP message or the MOB_BSHO-REQ message may fail.

Even if the MS 300 does not receive the MOB_BSHO-RSP message for a predetermined period of time, or irrespective of the reception of the MOB_BSHO-RSP message, the MS 300 may decide to perform the handover. Thus, the MS 300 transmits in step 315 a MOB_HO-IND message to the serving BS 330, notifying that the MS 300 will perform a handover to the target BS 360. Then, the MS 300 releases the call from the serving BS 330.

Table 1 is the suggested example of MOB_HO-IND configuration including Imminent_HO_try_indication as a form of message.

TABLE 1

| Syntax | Size (bits) | Notes |
|---|---|---|
| MOB_HO-IND message format ( ) { | | |
| Management Message Type = 59 | 8 | |
| reserved | 6 | shall be set to zero. |
| Mode | 2 | 0b00: HO |
| | | 0b01: MDHO/FBSS: Anchor BS update |
| | | 0b10: MDHO/FBSS: Diversity Set update |
| | | 0b11: reserved |
| if(Mode == 0b00) { | | |
| HO_IND_type | 2 | 0b00: serving BS release |
| | | 0b01: HO cancel |
| | | 0b10: HO reject |
| | | 0b11: reserved |
| Ranging_Params_valid_indication | 2 | 0b00: No indication. BS ignores this field |
| | | (Default) |
| | | 0b01: MS ranging parameters for Target BS |
| | | which is specified in this message are valid. |
| | | 0b10: MS has no valid ranging parameters for |
| | | Target BS, which is specified in this message. |
| | | 0b11: Reserved |
| Imminent_HO_try_indication | 1 | When MS has received MOB_BSHO_REQ |
| | | or MOB_BSHO_RSP from serving BS, this |
| | | value shall be set to zero. The value of 1 |
| | | means that MS is trying imminent handover |
| | | due to the failure of management message |
| | | exchanges. BS may refer this bit to determine |
| | | the validity of handover information that |
| | | transmitted by MOB_BSHO-REQ or MOB- |
| | | BSHO-RSP. |
| Reserved | 3 | Shall be set to zero |
| if(HO_IND_type == ob00) { | | |
| Target_BS_ID | 48 | |
| } | | |
| } | | |
| ... | | |
| } | | |

Referring to Table 1, the MOB_HO-IND message has includes Management Message Type identifying the MOB_HO-IND message, a reserved area set to all 0s, and Mode indicating the operation of this message.

If Mode is set to 0b00 indicating a handover, the MOB_HO-IND message further includes HO_IND type, Ranging_Parameters_valid_indication (Ranging_Params_valid_indication, for short), Imminent_HO_try_indication, and Reserved set to all 0s. In this example, one of the bits of a conventional Reserved field (4 bit) is allocated to the Imminent_HO_try_indication.

In accordance with the present invention, the MS 300 notifies the serving BS 330 especially by the Imminent_HO_try_indication.

If the handover process is normal without message loss, the MS 300 transmits a MOB_HO-IND message with Imminent_HO_try_indication set to 0 to the serving BS 330. For Imminent_HO_try_indication=0,the serving BS 330 performs the handover process as conventionally done and notifies the target BS 360 of the normal handover process by transmitting the Imminent_HO_try_indication set to 0 or by a predetermined message designed to indicate whether the handover process is normal or not. Confirming the normal handover process, the target BS 360 can use an HO_ID and the MS 300 can also perform network re-entry to the target BS 360 using the HO_ID. Thus, the target BS 360 transmits a Fast_Ranging_IE using the HO_ID to the MS 300.

If the handover process is abnormal due to message loss, the MS 300 transmits a MOB_HO-IND message with Imminent_HO_try_indication set to 1 to the serving BS 330 in step 315. For Imminent_HO_try_indication=0, the serving BS 330 performs the handover process as conventionally done and notifies the target BS 360 of the abnormal handover process by transmitting in step 317 the Imminent_HO_try_indication set to 1 or by the predetermined message. Thus, the target BS 360 determines that handover information transmitted to the MS 300 during the handover process is not valid. As illustrated in FIG. 3, therefore, the target BS 360 uses, for example, the MAC address of the MS 300 in allocating an uplink period to the MS 300 by a Fast_Ranging_IE and the MS 300 performs the network re-entry to the target BS 360 using the MAC address.

In step 319, the target BS 360 transmits the Fast_Ranging_IE with the MAC address to the MS 300. As the MS 300 does not acquire handover information successfully due to the reception failure of the MOB_BSHO-RSP message, the target BS 360 support handover to the MS 300 using the MAC address, for a call setup.

Upon receipt of the Fast_Ranging_IE, the MS 300 transmits in step 321 an RNG-REQ message in a UL BW allocated from the target BS 360 to the target BS 360, for the ranging.

It has been described above with reference to FIG. 3 that in the case of an abnormal handover process, a handover is performed by adding Imminent_HO_try_indication to a MOB_HO-IND message. Now a description will be made of a handover operation in case of failed transmission/reception of the MOB_HO-IND message.

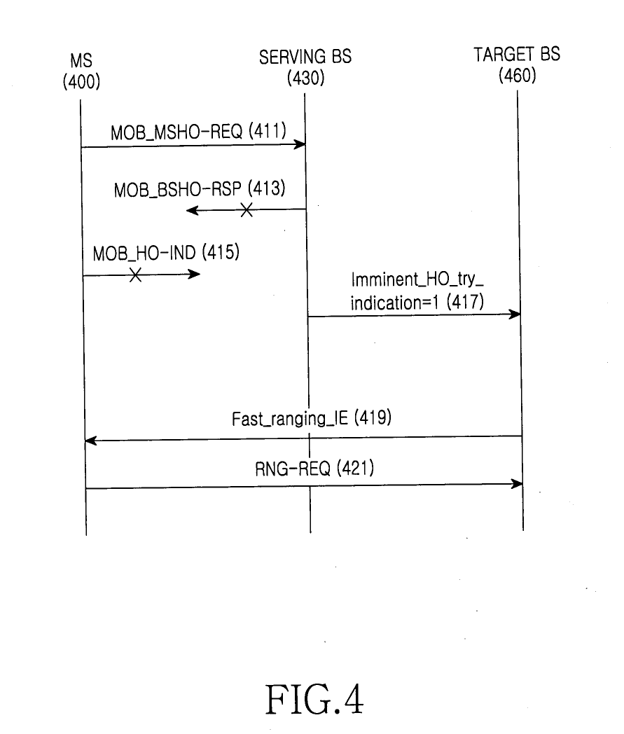

FIG. 4 a diagram illustrating a signal flow for a handover process in case of loss of a MOB_HO-IND message in the communication system according to an exemplary embodiment of the present invention.

The handover process illustrated in FIG. 4 is performed in a similar manner to that illustrated in FIG. 3, except that the former relates to a failed transmission/reception of the MOB_HO-IND message. The same steps as shown in FIG. 3 will not be described herein.

Referring to FIG. 4, during a handover process among an MS 400, a serving BS 430, and a target BS 460, the MS 400 performs a service with the serving BS 430 by setting up a call. The MS 400 receives reference signals, for example, pilot signals from neighbor BSs, measures the CINRs of the pilot signals, and determines whether or not to change the serving BS 430, that is, whether to perform a handover.

If the MS 400 determines to change the serving BS from the current serving BS 430 to another BS, the MS 400 transmits a MOB_MSHO-REQ message to the serving BS 430 in step 411. The MOB_MSHO-REQ message is a MAC layer message carrying neighbor BS information that the MS 400 has measured to perform a handover to another BS.

The serving BS 330 replies to the MS 300 with a MOB_BSHO-RSP message in step 413.

However, since messages are exchanged between the MS 400 and the BSs 430 and 460 at a cell boundary where the strengths of signals are weakened or in a handover region, the messages have a high transmission/reception failure probability. Hence, the MS 400 may fail to receive the MOB_BSHO-RSP message successfully in step 413 in the illustrated case of FIG. 4.

Due to the failure of receiving the MOB_BSHO-RSP message, the MS 400 does not acquire the handover information about the neighbor BSs needed for a normal handover. The handover information contains service level prediction information, handover process optimization information, HO-ID information, HO authorization_policy_support information, and the like.

While not shown in FIG. 4 describing an MS-initiated handover, transmission/reception errors may occur in a MOB_BSHO-REQ message that the serving BS 430 transmits in the case of a BS-initiated handover. That is, reception of the MOB_BSHO-RSP message or the MOB_BSHO-REQ message may fail.

Even if the MS 400 does not receive the MOB_BSHO-RSP message for a predetermined period of time, or irrespective of the reception of the MOB_BSHO-RSP message, the MS 400 may decide to perform the handover. Thus, the MS 400 transmits in step 415 a MOB_HO-IND message to the serving BS 430, notifying that the MS 400 will perform a handover to the target BS 360. Then, the MS 400 releases the call from the serving BS 430.

Besides the MOB_BSHO-RSP message, the transmission/reception of the MOB_HO-IND message may fail as well. In this case, therefore, the serving BS 430 cannot find out whether the handover process is normal or not by Imminent_HO_try indication.

In relation to the reception failure of the MOB_HO-IND message, the serving BS 430 sets the Imminent_HO_try_indication to 1 and transmits in step 417 the Imminent_HO_try_indication set to 1 to the target BS 460. Alternatively, the serving BS 430 notifies the target BS of the abnormal handover process by transmitting a predetermined message designed for this purpose.

Therefore, the target BS 460 uses the MAC address of the MS 400 and the MS 400 also uses its MAC address during network re-entry to the target BS 460.

In step 419, the target BS 460 transmits the Fast_Ranging_IE with the MAC address to the MS 400. As the MS 400 does not acquire handover information successfully due to the reception failure of the MOB_BSHO-RSP message, the target BS 460 performs ranging with the MS 400 using the MAC address, for a call setup.

Upon receipt of the Fast_Ranging_IE, the MS 400 transmits in step 421 an RNG-REQ message in a UL BW allocated from the target BS 460 to the target BS 460, for the ranging.

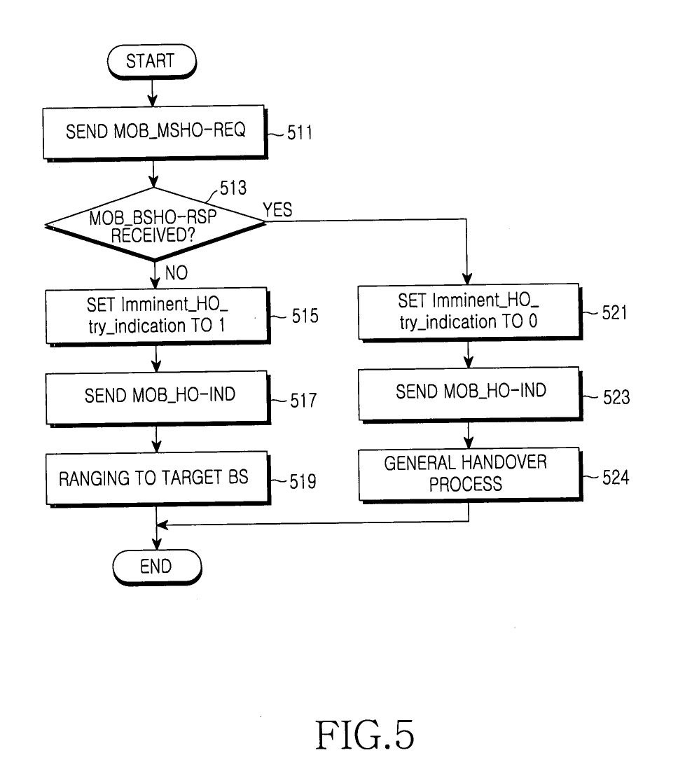

FIG. 5 is a flowchart illustrating a handover operation of the MS according to an exemplary embodiment of the present invention.

Referring to FIG. 5, the MS performs a service with the serving BS by setting up a call. The MS receives reference signals, for example, pilot signals from neighbor BSs, measures the CINRs of the pilot signals, and determines whether to perform a handover. If the MS determines that the handover is required, the MS transmits a MOB_MSHO-REQ message to the serving BS in step 511.

In step 513, the MS determines whether the handover process proceeds normally, that is, whether a MOB_BSHO-RSP message has been received in response to the transmitted MOB_MSHO-REQ message from the serving BS. If the MS has not received the MOB_BSHO-RSP message during a predetermined period of time or after a retransmission request, the MS proceeds to step 515. Upon receipt of the MOB_BSHO-RSP message, the MS proceeds to step 521.

In step 515, the MS sets Imminent_HO_try_indication to 1, considering that the handover process runs abnormally because of the failed reception of the MOB_BSHO-RSP message.

The MS transmits in step 517 a MOB_HO-IND message with the Imminent_HO_try_indication set to 1, having the configuration of Table 1 to the serving BS, notifying of the abnormal handover process. The MS then releases the call from the serving BS and performs handover to the target BS.

In step 519, the MS performs ranging to the target BS. Since handover information about the MS in the target BS is not valid due to the abnormal handover process, the ranging is performed using the MAC address of the MS.

In case of a successful reception of the MOB_BSHO-RSP message in step 513, the MS operates normally according to the handover process.

Thus, the MS sets in step 521 the Imminent_HO_try_indication to 0, considering that the handover process runs normally because of the successful reception of the MOB_BSHO-RSP message.

The MS transmits in step 523 a MOB_HO-IND message with the Imminent_HO_try_indication set to 0 to the serving BS. The MS then performs the handover in a general manner. The target BS allocates a ranging bandwith for ranging to the MS using an HO_ID as conventionally done.

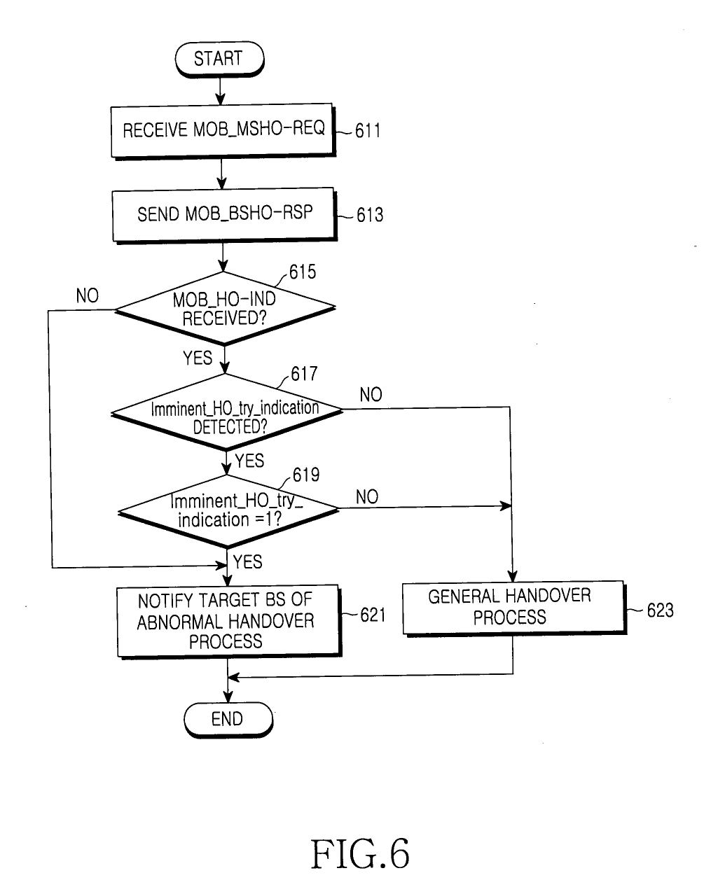

FIG. 6 is a flowchart illustrating a handover operation of the serving BS according to an exemplary embodiment of the present invention.

Upon receipt in step 611 of a MOB_MSHO-REQ message including MS-measured neighbor BS information, requesting a handover from the MS, the serving BS replies to the MS with a MOB_BSHO-RSP message in step 613.

In step 615, the serving BS monitors reception of a MOB_HO-IND message from the MS. If the serving BS has not received the MOB_HO-IND message from the MS, the serving BS notifies in step 721 the target BS that the handover process is abnormal.

Upon receipt of the MOB_HO-IND message from the MS, the serving BS determines whether the received message includes Imminent_HO_try_indication in step 617. In the absence of the Imminent_HO_try_indication, the serving BS operates according to a normal handover process in step 623.

In the presence of the Imminent_HO_try_indication, the serving BS determines in step 619 if the Imminent_HO_try_indication is set to 1. If the Imminent_HO_try_indication is 0, the serving BS operates according to the normal handover process in step 623. If the Imminent_HO_try_indication is 1, which implies the handover process is abnormal, the serving BS proceeds to step 621.

In step 621, the serving BS notifies the target BS of the abnormal handover process by transmitting the Imminent_HO_try_indication set to 0 or a predetermined message designed to indicate whether a handover process is normal or not.

In this way, the serving BS can determine whether the handover process is normal or not as in step 615 and, in the case of an abnormal handover process, the serving BS notifies the target BS of the abnormal handover process.

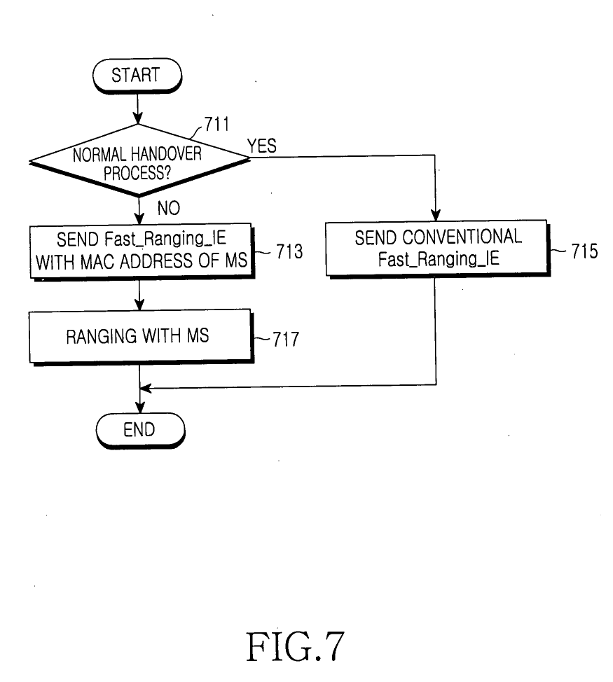

FIG. 7 is a flowchart illustrating a handover operation of the target BS according to an exemplary embodiment of the present invention.

Referring to FIG. 7, the target BS determines in step 711 whether the handover process is normal by Imminent_HO_try_indication received form the serving BS or by a predetermined message designed to indicate whether a handover process is normal or not. If the Imminent_HO_try_indication is 0 or if the target BS determines that the handover process is normal based on the predetermined message, the target BS proceeds to step 715. On the other hand, if the Imminent_HO_try_indication is 1 or if the target BS determines that the handover process is abnormal based on the predetermined message, the target BS proceeds to step 713.

The target BS performs a general ranging procedure and thus transmits a Fast_Ranging_IE to the MS in step 715. The MS operates according to the normal handover process and handover information that the MS has is valid. Hence, the target BS is able to perform the handover using an HO_ID.

On the other hand, the target BS transmits in step 713 a Fast_Ranging_IE using the MAC address of the MS to the MS because the handover information is not valid.

After step 713 or 715, the target BS performs a ranging procedure with the MS in step 717.

The present invention is based on the premise that the MS can perform the handover using the HO-ID as well as the MAC address.

As described above, when the handover process runs abnormally, i.e. errors are detected in the handover process, the target BS is informed of the abnormal implementation of the handover process.

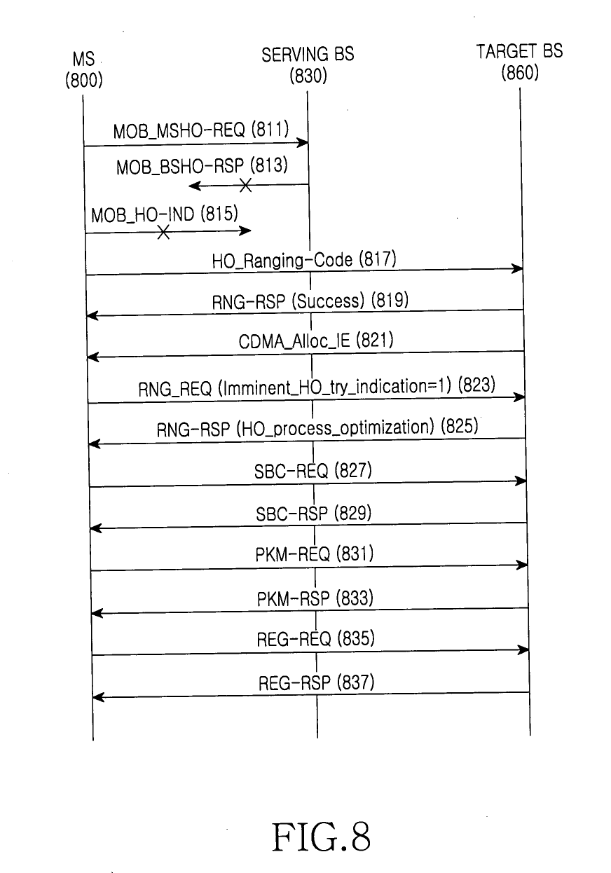

FIG. 8 is a diagram illustrating a signal flow for a handover process in the communication system according to another exemplary embodiment of the present invention.

The handover process illustrated in FIG. 8 is performed in the case of a failed transmission/reception of a MOB_BSHO-RSP message, a MOB_BSHO-REQ message, and a MOB_HO-IND message. The same steps as shown in FIGS. 3 and 4 will not be described in detail herein.

Referring to FIG. 8, during a handover process among an MS 800, a serving BS 830, and a target BS 860, the MS 800 performs a service with the serving BS 830 by setting up a call. The MS 800 determines whether to change the serving BS 830, that is, whether to perform a handover.

If the MS 800 determines to change the serving BS from the current serving BS 830 to another BS, the MS 800 transmits a MOB_MSHO-REQ message to the serving BS 830 in step 811.

The serving BS 830 replies to the MS 800 with a MOB_BSHO-RSP message in step 813.

However, since messages are exchanged between the MS 800 and the BSs 830 and 860 at a cell boundary where the strengths of signals are weakened or in a handover region, the messages have a high transmission/reception failure probability. Hence, the MS 800 may fail to receive the MOB_BSHO-RSP message successfully in step 813 in the illustrated case of FIG. 8.

Due to the failure of receiving the MOB_BSHO-RSP message, the MS 800 does not acquire handover information about the neighbor BSs needed for a normal handover. The handover information contains service level prediction information, handover process optimization information, HO-ID information, HO_authorization_policy_support information, and the like.

While not shown in FIG. 8 describing an MS-initiated handover, transmission/reception errors may occur in a MOB_BSHO-REQ message that the serving BS 830 transmits in the case of a BS-initiated handover. That is, reception of the MOB_BSHO-RSP message or the MOB_BSHO-REQ message may fail.

Even if the MS 800 does not receive the MOB_BSHO-RSP message for a predetermined period of time, or after transmitting a retransmission request, the MS 800 may decide to perform the handover without the MOB_BSHO-RSP message. In this case, the MS 800 transmits in step 815 a MOB_HO-IND message to the serving BS 830, notifying that it will perform a handover to the target BS 860. Then, the MS 800 releases the call from the serving BS 830.

Besides the MOB_BSHO-RSP message, the transmission/reception of the MOB_HO-IND message may also fail.

Compared to the handover processes illustrated in FIGS. 3 and 4 in which the target BS is informed of the abnormal handover process by the Imminent_HO_try_indication, so that the target BS performs the handover using the MAC address of the MS, the target BS is informed of the abnormal handover process by an RNG-REQ message instead of the MOB_HO-IND message or the predetermined message transmitted over a backbone network, indicating whether the handover process is normal or not (i.e. including information provided by the Imminent_HO_try_indication).

In step 817, the MS 800 transmits a HO_Ranging-Code to the target BS 860, for the handover.

The target BS 860 replies in step 819 to the MS 800 with an RNG-RSP message indicating that a successful ranging is possible for the HO_Ranging-Code. Then, the target BS 860 transmits in step 821 a CDMA_Alloc_IE to the MS 800, thus allocating a UL BW in which the MS 800 will transmit an RNG-REQ message.

After acquiring downlink synchronization with the target BS 860, the MS 800 should perform an uplink operation by ranging to the target BS 860 to thereby acquire uplink synchronization and be capable of controlling transmit power. Thus, the MS 800 transmits the RNG-REQ message to the target BS 860 in step 823.

In accordance with the exemplary embodiment of the present invention, the RNG-REQ message delivers Imminent_HO_try_indication to the target BS, by which the target BS determines the validity of the handover information, particularly the handover authorization policy support information transmitted to the MS by the MOB_BSHO-RSP message or the MOB_BSHO-REQ message. Therefore, when the MS receives the MOB_BSHO-RSP message or the MOB_BSHO-REQ message successfully, the MS sets the Imminent_HO_try_indication to 0 and transmits it to the target BS. If the MS fails to receive the MOB_BSHO-RSP message or the MOB_BSHO-REQ message, the MS sets the Imminent_HO_try_indication to 1 and transmits it to the target BS.

When the Imminent_HO_try_indication is 0, the following operation is based on the conventional handover process. If the Imminent_HO_try_indication is set to 1, the target BS performs the handover without skipping any process because the handover information transmitted to the MS by the MOB_BSHO-RSP message or the MOB_BSHO-REQ message is not valid. Specifically, if the Imminent_HO_try indication is set to 1, which implies that an Authorization_Policy_Support value transmitted to the MS by the serving BS is lost, the target BS commands the MS to perform the entire initial authentication procedure.

The Imminent_HO_try_indication is added in the form of TLV in the RNG_REQ message and configured as shown in Table 2.

TABLE 2

| Name | Type | Length | Value |
|---|---|---|---|
| Imminent_HO_Try_indication | — | 1 (bit) | When MS has received MOB_BSHO_REQ or |
| | | | MOB_BSHO_RSP from serving BS, this value shall |
| | | | be set to zero. The value of 1 means that MS is trying |
| | | | imminent handover due to the failure of management |
| | | | message exchanges. Default value is 1. |
| | | | BS may refer this bit to determine the validity of |
| | | | handover information that transmitted by |
| | | | MOB_BSHO-REQ or MOB-BSHO-RSP. Default |
| | | | value is 1. |

HO_process_optimization field is a TLV in an RNG-RSP message. The HO_process_optimization field can be used to minimize a service delay during the handover by minimizing the handover process with the target BS 860.

In accordance with the exemplary embodiment of the present invention, the serving BS 830 or the target BS 860 notifies the MS 800 of processes that can be skipped during the handover. The HO_process_optimization field has the format shown in Table 3.

TABLE 3

| Bit number | Notes |
|---|---|
| 0 | Omit SBC-REQ/RSP management message during re-entry processing |
| 1 | Omit PKM-Authentication phase except TEK phase during current re-entry processing |
| 2 | Omit PKM-TEK creation phase during current re-entry processing |
| 3 | Omit REG-REQ/RSP management message during current re-entry processing |
| 4 | Omit Network Address Acquisition management messages during current re-entry |
| | processing |
| 5 | Omit Time of Day Acquisition management messages during current re-entry processing |
| 6 | Omit TFTP management message during current re-entry processing |
| 7 | Full service and operational state transfer or sharing between serving BS and target BS |
| | (ARQ, timers, counters, MAC state machines, etc.) |

Referring to Table 3,the HO_process_optimization field is an 8-bit field indicating whether individual processes required for network re-entry should be performed. The respective eight bits indicate whether the respective processes required for the network re-entry to the target BS 860 after the handover from the serving BS 830 to the target BS 860 can be skipped.

In the HO Optimization field, bit #0 indicates whether SBC-REQ and SBC-RSP messages are to be omitted between the MS 800 and the target BS 860. If bit #0 is 0, this implies that the SBC-REQ and SBC-RSP messages are to be exchanged between the MS 800 and the target BS 860. If bit #0 is 1, this implies that the SBC-REQ and SBC-RSP messages will not be exchanged between the MS 800 and the target BS 860.

For example, bit #1 indicates whether PKM-REQ and PKM-RSP messages, except a PKM-TEK phase, are to be omitted between the MS 800 and the target BS 860. If bit #1 is 0, this implies that the PKM-REQ and PKM-RSP messages are to be exchanged between the MS 800 and the target BS 860. If bit #1 is 1, this implies that the PKM-REQ and PKM-RSP messages will not be exchanged between the MS 800 and the target BS 860.

For example, bit #2 indicates whether the PKM-TEK phase is to be omitted between the MS 800 and the target BS 860; If bit #2 is 0, this implies that the PKM-TEK phase is to be performed between the MS 800 and the target BS 860. If bit #2 is 1, this implies that the PKM-TEK phase will not be performed between the MS 800 and the target BS 860.

For example, bit #3 indicates whether REG-REQ and REG-RSP messages are to be omitted between the MS 800 and the target BS 860. If bit #3 is 0, this implies that the REG-REQ and REG-RSP messages are to be exchanged between the MS 800 and the target BS 860. If bit #3 is 1, this implies that the REG-REQ and REG-RSP messages will not be exchanged between the MS 800 and the target BS 860.

For example, bit #4 indicates whether Network Address Acquisition management messages are to be omitted between the MS 800 and the target BS 860. If bit #4 is 0, this implies that the Network Address Acquisition management messages are to be exchanged between the MS 800 and the target BS 860. If bit #4 is 1, this implies that the Network Address Acquisition management messages will not be exchanged between the MS 800 and the target BS 860. The Network Address Acquisition management messages are messages by which the MS 800 acquires a network address from the target BS 860.

For example, bit #5 indicates whether Time of Day Acquisition management messages are to be omitted between the MS 800 and the target BS 860. If bit #5 is 0, this implies that the Time of Day Acquisition management messages are to be exchanged between the MS 800 and the target BS 860. If bit #5 is 1, this implies that the Time of Day Acquisition management messages will not be exchanged between the MS 800 and the target BS 860. The Time of Day Acquisition management messages are messages by which the MS 800 newly acquires time information from the target BS 860.

For example, bit #6 indicates whether Trivial File Transfer Protocol (TFTP) management messages are to be omitted between the MS 800 and the target BS 860. If bit #6 is 0, this implies that the TFTP management messages are to be exchanged between the MS 800 and the target BS 860. If bit #6 is 1, this implies that the TFTP management messages will not be exchanged between the MS 800 and the target BS 860.

For example, bit #7 indicates whether the MS 800 can immediately carry out a normal service in the target BS 860 without any additional process due to full transfer of information about the service and operational statuses of the MS 800 within the serving BS 830 from the serving BS 830 to the target BS 860 or sharing the information between the serving BS 830 and the target BS 860. If bit #7 is 1, this implies that the MS 800 can immediately carry out a normal service in the target BS 860 without any additional process. If bit #7 is 0, this implies that the MS 800 can not immediately carry out a normal service in the target BS 860 without any additional process. The service and operational status information may include Automatic Repeat request (ARQ) status information, timer values, counter values, MA state machine values, etc.

If the HO_process_optimization field is included in a Neighbor Advertisement (NBR-ADV) message and the MOB_BSHO-RSP message, the HO_process_optimization field is provided as part of information about neighbor BSs to which a handover is available. When the MS moves to the target BS, the target BS may change the meanings of the respective bits of the HO_process_optimization field. On the other hand, if he HO_process_optimization field is included in the RNG-RSP message, the HO_process_optimization field functions to specify which processes are to be omitted and which processes are to be performed during the network re-entry to the target BS.

In accordance with the exemplary embodiment of the present invention, the target BS 860 decides on a process to be omitted according to the Imminent_HO_try_indication received from the MS 800, considering that handover information is delivered by the MOB_BSHO-REQ message or the MOB_BSHO-RSP message in relation to the process omission and failed transmission/reception of the MOB_BSHO-REQ message or the MOB_BSHO-RSP message leads to implementation of the full handover process.

For instance, if the Imminent_HO_try_indication is 1, the target BS 860 transmits in step 825 to the MS 800 an RNG-RSP message with the HO_process_optimization field set to a value so that the MS 800 neglects the handover information associated with the PKM process omission and performs a PKM process during the network re-entry.

Thus, the MS 800 performs the following handover process according to the value of the HO_process_optimization field.

After the ranging, the MS 800 transmits in step 827 an SBC-REQ message to the target BS 860 in order to negotiate the basic capabilities of the MS 800. The SBC-REQ message is a MAC layer message containing a modulation and coding scheme supportable by the MS 800. The target BS 860, which checks the MS-supported modulation and coding scheme from the SBC-REQ message, replies to the MS 800 with an SBC-RSP message in step 829.

Upon receipt of the SBC-RSP message, the MS 800 transmits in step 831 a PKM-REQ message to the target BS 860, for MS authentication and key exchange. The PKM-REQ message is a MAC layer message for authentication of the MS 800, containing certificate information regarding the MS 800. The target BS 860 performs authentication with an AS (not shown) using the certificate information. If the MS 800 is authenticated, the target BS 860 transmits a PKM-RSP message to the MS 200 in step 833. The PKM-RSP message includes an AK and a TEK, both allocated to the MS 800.

The MS 800 transmits an REG-REQ message to the target BS 860 in step 835. The REG-REQ message includes MS registration information regarding the MS 800. The target BS 860 detects the MS registration information in the REG-REQ message, registers the MS 800 to the target BS 860, and then transmits an REG-RSP message to the MS 800 in step 837. The REG-RSP message includes the MS registration information about the registered MS 800.

When the registration to the target BS 860 is completed, the MS 800 sets up an IP connection to the target BS 860 or transmits the operation parameters to the target BS 860 depending on the type of the MS 800 or whether information about the MS 800 is shared and transferred between the BSs 830 and 860. The IP connection setup or the transmission of operation parameters is optional. Then, the MS 800 reconfigures a flow serviced by the serving BS 830, thus reconfiguring a connection. With the connection reconfiguration, the MS 800 is now able to carry out a communication service normally with the target BS 860.

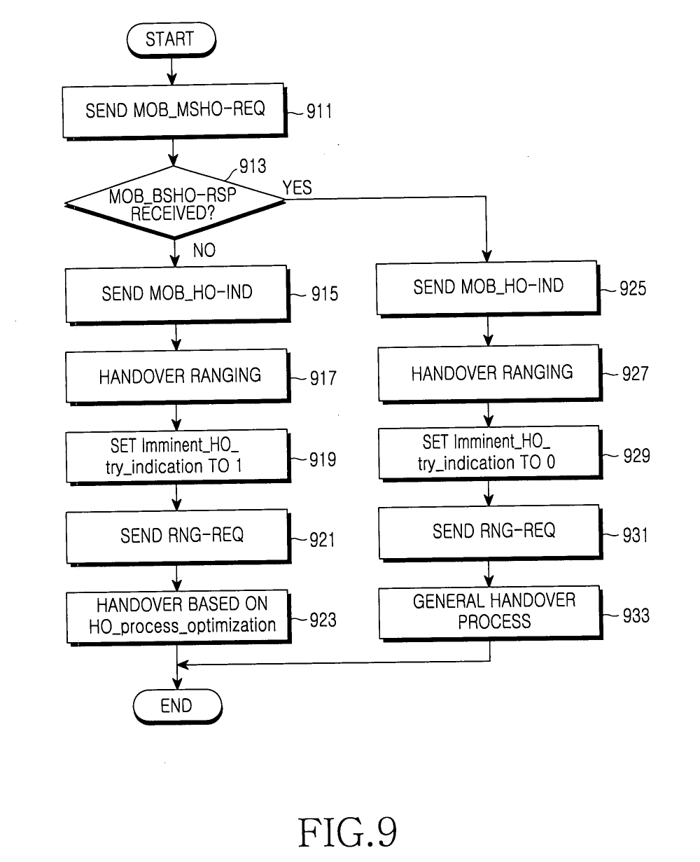

FIG. 9 is a flowchart illustrating a handover operation of the MS according to another exemplary embodiment of the present invention.

Referring to FIG. 9, the MS performs a service with the serving BS by setting up a call. The MS receives reference signals, for example, pilot signals, from neighbor BSs, measures the CINRs of the pilot signals, and determines whether to perform a handover. If the MS determines that a handover is required, the MS transmits a MOB_MSHO-REQ message to the serving BS in step 911.

In step 913, the MS determines whether the handover process proceeds normally, that is, whether a MOB_BSHO-RSP message has been received for the transmitted MOB_MSHO-REQ message from the serving BS. If the MS has not received the MOB_BSHO-RSP message during a predetermined period of time or after a retransmission request, the MS proceeds to step 915. Upon receipt of the MOB_BSHO-RSP message, the MS proceeds to step 925.

In step 915, the MS transmits a MOB_HO-IND message to the serving BS a predetermined time later, or a predetermined time after retransmitting the MOB_MSHO-REQ message.

The MS performs a handover ranging in step 917. The MS can be allocates a UL BW using a ranging code.

In step 919, the MS sets Imminent_HO_try_indication to 1, considering that the handover process runs abnormally because of the failed reception of the MOB_BSHO-RSP message.

The MS transmits to the target BS in step 921 an RNG-REQ message with the Imminent_HO_try_indication set to 1, thus notifying the target BS of the abnormal handover process.

The MS performs in step 923 the subsequent handover process based on an HO_process_optimization received from the target BS.

On the other hand, the MS transmits a MOB_HO-IND message to the serving BS in step 925 and performs a handover ranging in step 927. Here, the MS can be allocated a UL BW using a ranging code.

In step 929, the MS sets Imminent_HO_try_indication to 0, considering that handover information for the MS is valid because of the successful reception of the MOB_BSHO-RSP message. The MS transmits in step 931 an RNG-REQ message with the Imminent_HO_try_indication set to 0 to the target BS. The MS performs the subsequent handover process in a conventional manner in step 933.

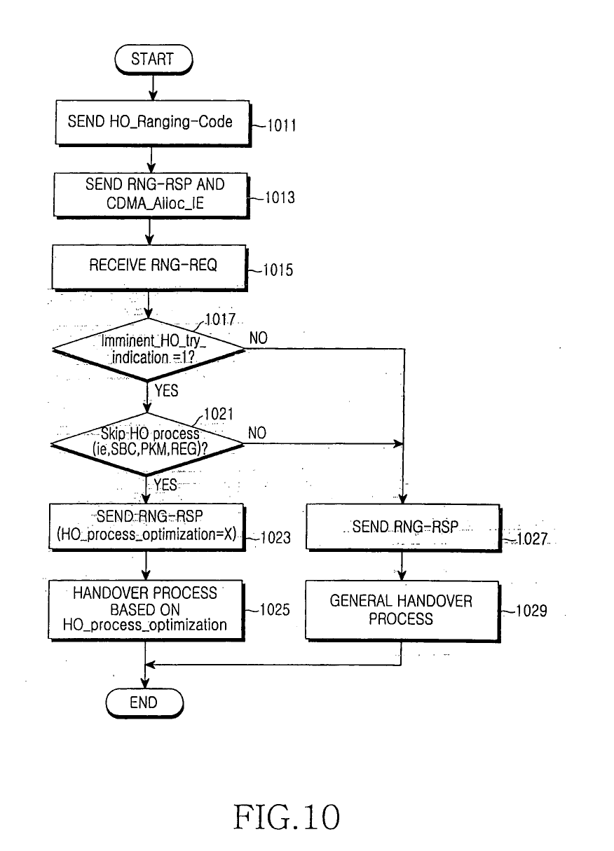

FIG. 10 is a flowchart illustrating a handover operation of the target BS according to another exemplary embodiment of the present invention.

Referring to FIG. 10, upon receipt of an HO_Ranging-Code from the MS in step 1011, the target BS transmits in step 1013 an RNG-RSP message and a CDMA_Alloc_IE to the MS, when a UL BW for ranging can be allocated to the MS.

The target BS receives an RNG-REQ message from the MS in step 1015 and determines in step 1017 whether the Imminent_HO_try_indication set in the RNG-REQ message is 1. If the Imminent_HO_try_indication is 1, the target BS proceeds step 1021. If the Imminent_HO_try_indication is 0, the target BS transmits a general RNG-RSP message in step 1027 and operates according to the general handover process in step 1029.

In step 1021, the target BS determines whether a process such as SBC, PKM, or REG can be skipped. If the process is not to be skipped, the target BS proceeds to step 1027.

If the process is to be skipped, the target BS sets HO_process_optimization to X according to the process and transmits an RNG-RSP message with the HO_process_optimization in step 1023. The target BS operates according to the HO_process_optimization value in step 1025.

When there is no process to be skipped, the target BS transmits a general RNG-RSP message or sets the HO_process_optimization to 0 in step 1027 and operates according to the general handover process in step 1029.

Since the serving BS operates in a similar manner as that of a conventional serving BS, its description will not be provided.

It has been described above that a handover is performed without a serving delay or malfunction even though handover information of the MS is invalid, since the MS notifies the serving BS or the target BS of an abnormal implementation of a handover process by the Imminent_HO_try_indication. In accordance with the afore-described exemplary embodiments, the MS can notify that its handover information is invalid by transmitting a MOB_HO-IND message or an RNG-REQ message each including the Imminent_HO_try_indication. Because of the different transmitted messages, these exemplary embodiments can be implemented, separately or in combination.

As is apparent from the above description, the present invention minimizes a service delay during a handover because an MS notifies a serving BS or a target BS of an abnormal handover process and thus of the invalidity of the existing handover information and thus the target BS and the terminal perform a ranging procedure, taking into account of the abnormal handover process. Despite an HO-ID mismatch between the MS and the BSs, the handover can be implemented. Furthermore, when the handover process is abnormal, some of the processes for the handover can be skipped by an HO_process_optimization field in an RNG-RSP message.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A handover method of a Mobile Station (MS) in a communication system, the method comprising:
determining by the MS that a handover is required; and
notifying a serving Base Station (BS) of the failed reception of handover information if the MS does not receive a BS handover message transmitted from the serving BS and tries cell switching to a target BS.

2. The handover method of claim 1, wherein during the determining step a handover indication message is transmitted from the MS to the serving BS.

3. The handover method of claim 1, wherein the BS handover message includes at least one of a BS handover response message and a BS handover request message.

4. The handover method of claim 2, wherein the BS handover response message is a response message for a MS handover request message transmitted from the MS to the serving BS.

5. The handover method of claim 1, wherein the notification step comprises transmitting to the serving BS a message indicating the failed reception of the handover information.

6. The handover method of claim 1, wherein the notification step comprises transmitting to the serving BS a handover indication message with an indication indicating the failed reception of the handover information.

7. The handover method of claim 6, wherein the indication is a one predetermined bit.

8. The handover method of claim 7, wherein the one predetermined bit is one of existing reserved bits.

9. The handover method of claim 6, wherein the indication is inserted in the form of Type-Length-Value (TLV).

10. The handover method of claim 1, wherein the handover information includes at least one of service level prediction information, handover process optimization information, handover identification (HO-ID) information, and HO_authorization_policy_support information.

11. A handover method of a serving Base Station (BS) in a communication system, the method comprising:
receiving from a Mobile Station (MS) a notification indicating a failed reception of handover information; and
notifying a target BS of the failed reception of the handover information at the MS, the target BS being a BS to which the MS is to handover.

12. The handover method of claim 11, wherein the handover information is included in a BS handover message transmitted from the serving BS to the MS.

13. The handover method of claim 12, wherein the handover message includes at least one of a BS handover response message and a BS handover request message.

14. The handover method of claim 13, wherein the BS handover response message is a response message for a MS handover request message transmitted from the MS to the serving BS.

15. The handover method of claim 11, wherein the notification is a message indicating the failed reception of the handover information.

16. The handover method of claim 11, wherein the notification is a handover indication message with an indication indicating the failed reception of the handover information.

17. The handover method of claim 16, wherein the indication is one predetermined bit.

18. The handover method of claim 17, wherein the one predetermined bit is one of existing reserved bits.

19. The handover method of claim 16, wherein the indication is inserted in the form of Type-Length-Value (TLV).

20. The handover method of claim 11, wherein the notifying of the failed reception of the BS handover response message at the MS comprises transmitting to the target BS a message indicating the failed reception of the BS handover response message at the MS.

21. The handover method of claim 11, wherein the handover information includes at least one of service level prediction information, handover process optimization information, handover identification (HO-ID) information, and HO_authorization_policy_support information.

22. A handover method of a target Base Station (BS) in a communication system, the method comprising:
receiving from a Mobile Station (MS) a notification of a failed reception at the MS of handover information transmitted by a serving BS; and
allocating a bandwidth for ranging to the MS using a unique handover Identifier (ID) of the MS.

23. The handover method of claim 22, wherein the unique handover ID of the MS is a Medium Access Control (MAC) address of the MS.

24. The handover method of claim 22, wherein the handover information includes at least one of service level prediction information, handover process optimization information, handover identification (HO-ID) information, and HO_authorization_policy_support information.

25. A handover method of a Mobile Station (MS) in a communication system, the method comprising:
determining by the MS that a handover is required;
transmitting a handover indication message to a target BS to which the handover is to be performed;
implementing the handover with the target BS; and
notifying the target BS of a failed reception of handover information if the MS fails receive the handover information.

26. The handover method of claim 25, wherein the handover information is included in a BS handover message transmitted from the serving BS to the MS.

27. The handover method of claim 26, wherein the BS handover message includes at least one of a BS handover response message and a BS handover request message.

28. The handover method of claim 27, wherein the BS handover response message is a response message for a MS handover request message transmitted from the MS to the serving BS.

29. The handover method of claim 25, wherein the handover implementation step comprises:
transmitting a handover ranging code to the target BS;
receiving from the target BS a ranging response message indicating that a successful ranging is possible for the handover ranging code; and
receiving from the target BS a Code Division Multiple Access (CDMA) information element allocating a bandwidth in which the MS can transmit a ranging request message.

30. The handover method of claim 25, wherein the notification step comprises transmitting to the target BS a message indicating the failed reception of the handover information.

31. The handover method of claim 25, wherein the notification step comprises transmitting to the target BS a ranging request message with an indication indicating the failed reception of the handover information.

32. The handover method of claim 31, wherein the indication is one predetermined bit.

33. The handover method of claim 32, wherein the indication is inserted in the form of Type-Length-Value (TLV).

34. The handover method of claim 32, further comprising receiving from the target BS a ranging response message in response to the ranging request message, wherein the handover implementation includes implementing the handover using handover process optimization information included in the ranging response message.

35. The handover method of claim 34, wherein the handover process optimization information indicates whether at least one of a basic capability negotiation request process, a privacy key management process, and a registration process is omitted or not.

36. The handover method of claim 25, wherein the handover information includes at least one of service level prediction information, handover process optimization information, handover identification (HO-ID) information, and HO_authorization_policy_support information.

37. A handover method of a target Base Station (BS) in a communication system, the method comprising:
implementing a handover with a Mobile Station (MS); and
receiving from the MS a notification of a failed reception at the MS of a handover information transmitted by a serving BS and determining that handover information about the MS is not valid.

38. The handover method of claim 37, wherein the handover information is included in a BS handover message transmitted from the serving BS to the MS.

39. The handover method of claim 38, wherein the BS handover message includes at least one of a BS handover response message and a BS handover request message.

40. The handover method of claim 37, wherein the handover implementation step comprises:
receiving a handover ranging code from the MS;
transmitting to the MS a ranging response message indicating that a successful ranging is possible for the handover ranging code; and
transmitting to the MS a Code Division Multiple Access (CDMA) information element allocating a bandwidth in which the MS can transmit a ranging request message.

41. The handover method of claim 37, wherein the notification reception step comprises receiving a message indicating the failed reception of the handover information.

42. The handover method of claim 37, wherein the notification reception step comprises receiving a ranging request message with an indication indicating the failed reception of the BS handover response message.

43. The handover method of claim 42, wherein the indication is one predetermined bit.

44. The handover method of claim 42, wherein the indication is inserted in the form of Type-Length-Value (TLV).

45. The handover method of claim 42, further comprising transmitting to the MS a ranging response message including handover process optimization information, for the ranging request message.

46. The handover method of claim 45, wherein the handover process optimization information indicates if at least one of a basic capability negotiation request process, a privacy key management process, and a registration process is omitted.

47. The handover method of claim 25, wherein the handover information includes at least one of service level prediction information, handover process optimization information, handover identification (HO-ID) information, and HO_authorization_policy_support information.

48. A handover apparatus in a communication system, the apparatus comprising:
a Mobile Station (MS) for determining that a handover is required, notifying a serving Base Station (BS) of a failed reception of a handover information if the MS does not receive a BS handover message transmitted MS from the serving BS and tries cell switching to a target BS.

49. The handover apparatus of claim 48, wherein during the handover determining a handover indication message from the MS to the serving BS.

50. The handover apparatus of claim 49, wherein the BS handover message includes at least one of a BS handover response message and a BS handover request message.

51. The handover apparatus of claim 50, wherein the BS handover response message is a response message for a MS handover request message transmitted from the MS to the serving BS.

52. The handover apparatus of claim 48, wherein the MS notifies the serving BS of the failed reception of the handover information through a message.

53. The handover apparatus of claim 48, wherein the MS notifies the serving BS of the failed reception of the BS by a handover indication message with an indication indicating the failed reception of the handover information to the serving BS.

54. The handover apparatus of claim 53, wherein the indication is one predetermined bit.

55. The handover apparatus of claim 54, wherein the one predetermined bit is one of existing reserved bits.

56. The handover apparatus of claim 53, wherein the indication is inserted in the form of Type-Length-Value (TLV).

57. The handover apparatus of claim 48, wherein the handover information includes at least one of service level prediction information, handover process optimization information, handover identification (HO-ID) information, and HO_authorization_policy_support information.

58. A handover apparatus in a communication system, the apparatus comprising:
a serving Base Station (BS) for receiving from a Mobile Station (MS) a notification indicating failed reception of a handover information, and notifying a target BS of the failed reception at the MS of the handover information, the target BS being a BS to which the MS is to handover.

59. The handover apparatus of claim 58, wherein the handover information is included in a BS handover message transmitted from the serving BS to the MS.

60. The handover apparatus of claim 59, wherein the handover message includes at least one of a BS handover response message and a BS handover request message.

61. The handover apparatus of claim 60, wherein the BS handover response message is a response message for a MS handover request message transmitted from the MS to the serving BS.

62. The handover apparatus of claim 58, wherein the serving BS receives a message indicating the failed reception of the handover information as the notification.

63. The handover apparatus of claim 58, wherein the serving BS receives a handover indication message with an indication indicating the failed reception of the handover information as the notification.

64. The handover apparatus of claim 63, wherein the indication is one predetermined bit.

65. The handover apparatus of claim 64, wherein the one predetermined bit is one of existing reserved bits.

66. The handover apparatus of claim 63, wherein the indication is inserted in the form of Type-Length-Value (TLV).

67. The handover apparatus of claim 58, wherein the serving BS notifies the target BS of the failed reception at the MS of the BS handover response message by transmitting to the target BS a message indicating the failed reception of the BS handover response message at the MS.

68. The handover apparatus of claim 58, wherein the handover information includes at least one of service level prediction information, handover process optimization information, handover identification (HO-ID) information, and HO_authorization_policy_support information.

69. A handover apparatus in a communication system, the apparatus comprising:
a target Base Station (BS) for receiving from a Mobile Station (MS) a notification of failed reception at the MS of a handover information transmitted by a serving BS, and allocating a bandwidth for ranging to the MS using a unique handover Identifier (ID) of the MS.

70. The handover apparatus of claim 69, wherein the unique handover ID of the MS is a Medium Access Control (MAC) address of the MS.

71. The handover apparatus of claim 69, wherein the handover information includes at least one of service level prediction information, handover process optimization information, handover identification (HO-ID) information, and HO_authorization_policy_support information.

72. A handover apparatus in a communication system, the apparatus comprising:
a Mobile Station (MS) for determining that a handover is required, transmitting a handover indication message to a target BS to which the handover is to be performed, implementing the handover with the target BS, and notifying the target BS of a failed reception of handover information if the MS does not receive the handover information.

73. The handover apparatus of claim 72, wherein the handover information is included in a BS handover message transmitted from the serving BS to the MS.

74. The handover apparatus of claim 73, wherein the BS handover message includes at least one of a BS handover response message and a BS handover request message.

75. The handover apparatus of claim 74, wherein the BS handover response message is a response message for a MS handover request message transmitted from the MS to the serving BS.

76. The handover apparatus of claim 72, wherein the MS transmits a handover ranging code to the target BS, receives from the target BS a ranging response message indicating that a successful ranging is possible for the handover ranging code, and receives from the target BS a Code Division Multiple Access (CDMA) information element allocating a bandwidth in which the MS can transmit a ranging request message.

77. The handover apparatus of claim 72, wherein the MS notifies the target BS of the failed reception of the handover information through a message.

78. The handover apparatus of claim 72, wherein the MS notifies the target BS of the failed reception of the BS handover response message by a ranging request message with an indication indicating the failed reception of the handover information.

79. The handover apparatus of claim 78, wherein the indication is one predetermined bit.

80. The handover apparatus of claim 79, wherein the indication is inserted in the form of Type-Length-Value (TLV).

81. The handover apparatus of claim 79, wherein the MS receives from the target BS a ranging response message in response to the ranging request message and implements the handover using handover process optimization information included in the ranging response message.

82. The handover apparatus of claim 81, wherein the handover process optimization information indicates if at least one of a basic capability negotiation request process, a privacy key management process, and a registration process is omitted.

83. The handover apparatus of claim 75, wherein the handover information includes at least one of service level prediction information, handover process optimization information, handover identification (HO-ID) information, and HO_authorization_policy_support information.

84. A handover apparatus in a communication system, the apparatus comprising:
a target Base Station (BS) for implementing a handover with a Mobile Station (MS), receiving from the MS a notification of failed reception at the MS of handover information transmitted by a serving BS, and determining that handover information about the MS is not valid.

85. The handover apparatus of claim 84, wherein the handover information is included in a BS handover message transmitted from the serving BS to the MS.

86. The handover apparatus of claim 85, wherein the BS handover message includes at least one of a BS handover response message and a BS handover request message.

87. The handover apparatus of claim 84, wherein the target BS receives a handover ranging code from the MS, transmits to the MS a ranging response message indicating a successful ranging is possible for the handover ranging code, and transmits to the MS a Code Division Multiple Access (CDMA) information element allocating a bandwidth in which the MS can transmit a ranging request message.

88. The handover apparatus of claim 84, wherein the target BS receives a message indicating the failed reception of the handover information as the notification.

89. The handover apparatus of claim 84, wherein the target BS receives a ranging request message with an indication indicating the failed reception of the BS handover response message as the notification.

90. The handover apparatus of claim 89, wherein the indication is one predetermined bit.

91. The handover apparatus of claim 89, wherein the indication is inserted in the form of Type-Length-Value (TLV).

92. The handover apparatus of claim 89, wherein the target BS transmits to the MS a ranging response message including handover process optimization information for the ranging request message.

93. The handover apparatus of claim 92, wherein the handover process optimization information indicates if at least one of a basic capability negotiation request process, a privacy key management process, and a registration process is omitted.

94. The handover apparatus of claim 93, wherein the handover information includes at least one of service level prediction information, handover process optimization information, handover identification (HO-ID) information, and HO_authorization_policy_support information.
